(19) United States
(12) Patent Application Publication
(10) Pub. No.: US 2025/0154363 A1
(43) Pub. Date: May 15, 2025

(54) PARAFFIN BASED CORROSION INHIBITOR COMPOSITIONS AND USES THEREOF

(71) Applicant: ChampionX LLC, Sugar Land, TX (US)

(72) Inventor: Jeremy Moloney, Katy, TX (US)

(21) Appl. No.: 18/928,457

(22) Filed: Oct. 28, 2024

Related U.S. Application Data
(60) Provisional application No. 63/598,574, filed on Nov. 14, 2023.

(51) Int. Cl. C09D 5/08; C09D 5/14; C09D 7/20; C09K 8/54

(52) U.S. Cl. CPC C09D 5/086; C09D 5/14; C09D 7/20; C09K 8/54

(57) ABSTRACT

The present disclosure relates generally to corrosion-inhibiting compositions, methods for improved corrosion inhibition of metal surfaces used in oil and gas operations, and treated metal containments. Corrosion-inhibiting compositions include a paraffinic oil solvent and corrosion inhibitor(s), wherein the paraffinic oil has about 5-40% paraffin content for improved corrosion inhibition.

### CROSS REFERENCE TO RELATED APPLICATIONS

This application claims priority under 35 U.S.C. § 119 to provisional patent application U.S. Ser. No. 63/598,574, filed Nov. 14, 2023, which is herein incorporated by reference in its entirety including without limitation, the specification, claims, and abstract, as well as any figures, tables, or examples thereof.

### TECHNICAL FIELD

The present disclosure relates generally to corrosion-inhibiting compositions, methods for improved corrosion inhibition of metal surfaces used in oil and gas operations, and treated metal containments. Corrosion-inhibiting compositions include a paraffinic oil solvent and corrosion inhibitor(s), wherein the paraffinic oil has about 5-40 wt-% paraffin content for improved corrosion inhibition performance and persistency.

### BACKGROUND

Corrosion remains a significant challenge in the oil and gas industry and are most often caused by salts and/or other dissolved solids, liquids, or gases that cause, accelerate, or promote corrosion of surfaces such as metal surfaces. Examples of corrodents include water electrolytes, such as sodium chloride, calcium chloride, oxygen, hydrogen sulfide, carbon dioxide, sulfur dioxide, and the like. Corrosion negatively impacts metal surfaces such as metal pipelines, tanks, and/or other metal equipment or devices used before, during, or after injection or production.

A majority of operators in the oil and gas extraction and processing industry employ corrosion inhibitors to reduce internal corrosion in metal surfaces which are contacted by aqueous liquids containing corrodents. Corrodents are found in injectates, produced water, connate (native water present in subterranean formations along with the hydrocarbon), and hydrocarbon liquids and solids. Corrosion inhibitors are added to the liquids which come into contact with metal surfaces where they act to prevent, retard, delay, reverse, and/or otherwise inhibit the corrosion of metal surfaces such as carbon-steel metal surfaces. Corrosion inhibitors are beneficial in that they extend the lifespan of metal surfaces, as well as permit the use of carbon steel components rather than more expensive metals, such as nickel, cobalt, and chromium alloys or other materials more expensive than carbon steel and/or which inherently entail other disadvantages in suitability for the purpose of liquid or gas containment.

Corrosion inhibitors when applied in a batch manner require the shutting down of a system or operation and therefore are often replaced with continuous dosing of application chemistries for corrosion inhibitors. When batch inhibitors are employed there is a need for improved chemistries to enhance the persistence of the corrosion inhibiting chemistries to minimize shutdowns of a system. As a result there is an ongoing need for improved batch corrosion inhibition compositions and methods to improve corrosion inhibition efficacy and persistence of films imparted by batch corrosion inhibitors.

It is therefore an object of this disclosure to provide corrosion-inhibiting compositions and methods for corrosion inhibition of metal surfaces that improve beyond the corrosion inhibition capability of existing corrosion inhibitors including those delivery corrosion inhibitors with conventional hydrocarbon solvents, such as xylene, by utilizing solvents comprising paraffinic oil having between about 5%-40% paraffinic content.

Other objects, embodiments and advantages of this disclosure will be apparent to one skilled in the art in view of the following disclosure, the drawings, and the appended claims.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is an object, feature, and/or advantage of the present disclosure to provide compositions and methods for inhibiting corrosion in oilfield systems, namely pipelines, containing oxygen.

According to some aspects of the present disclosure, corrosion-inhibiting compositions comprise from about 1 wt-% to about 75 wt-% of at least one corrosion inhibitor; and from about 25 wt-% to about 99 wt-% of at least one solvent comprising paraffinic oil, wherein the paraffinic oil has between about 5-40 wt-% paraffin content.

According to additional aspects of the present disclosure, use of the corrosion-inhibiting compositions described herein reduce, inhibit or prevent corrosion and metal wear of a metal surface in an oil-and-gas system.

According to still further aspects of the present disclosure, treated metal containments comprise: a metal containment comprising a metal surface; and a barrier or film substantially coating the metal surface with a corrosive inhibiting effective amount of the compositions described herein.

According to additional aspects of the present disclosure, methods of reducing, inhibiting or preventing both corrosion and metal wear of a metal surface comprise contacting a metal surface with a corrosion-inhibiting composition as described herein to reduce, inhibit or prevent both corrosion and metal wear of the metal surface, wherein the metal surface is used in recovery, transportation, refining or storage of a hydrocarbon fluid.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### DETAILED DESCRIPTION

It is further to be understood that all terminology used herein is for the purpose of describing particular embodiments only and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The terms “comprise(s)”, “include(s)”, “having”, “has”, “can”, “contain(s)”, and variants thereof, as used herein, are intended to be open-ended transitional phrases, terms, or words that do not preclude the possibility of additional acts or structures. The singular forms “a”, “and”, and “the” include plural references unless the context clearly dictates otherwise. The present disclosure also contemplates other embodiments “comprising”, “consisting of” and “consisting essentially of”, the embodiments or elements presented herein, whether explicitly set forth or not.

The methods and compositions of the present disclosure may comprise, consist essentially of, or consist of the components and ingredients of the present disclosure as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

Unless defined otherwise, all technical and scientific terms used above have the same meaning as commonly understood by one of ordinary skill in the art to which embodiments of the present disclosure pertain.

The term “about,” as used herein, refers to variation in the numerical quantity that can occur, for example, through typical measuring techniques and equipment, with respect to any quantifiable variable, including, but not limited to, concentration, mass, volume, time, molecular weight, molecular size, temperature, pH, molar ratios, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to linear or branched hydrocarbon radical, preferably having 1 to 32 carbon atoms (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons). Alkyls can include straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups). Commonly used alkyl groups include, but are not limited to, methyl, ethyl, n-propyl, isopropyl, n-butyl, iso-butyl, secondary-butyl, and tertiary-butyl.

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and urcido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups. In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

The terms “aryl” or “ar” as used herein alone or as part of another group (e.g., aralkyl) denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are commonly used aryls. The term “aryl” also includes heteroaryl.

“Arylalkyl” means an aryl group attached to the parent molecule through an alkylene group. In some embodiments the number of carbon atoms in the aryl group and the alkylene group is selected such that there is a total of about 6 to about 18 carbon atoms in the arylalkyl group. A commonly used arylalkyl group is benzyl.

As used herein, the term “containment” or “metal containment” includes any metal surface or portion thereof that is in contact with a gas or liquid phase from an oil-field system containing corrodents. In embodiments the containment is in fluid communication with one or more devices or apparatuses, including other containments. In embodiments the containment is a pipe. In embodiments the containment is a tank. In embodiments, the metal is steel. In embodiments, the steel is carbon steel. In embodiments, the carbon steel is stainless steel.

As used herein, the term “corrodent” refers to one or more salts and/or other dissolved solids, liquids, or gases that cause, accelerate, or promote corrosion of metals. Exemplary corrodents common in oil and gas applications include, water electrolytes, such as sodium chloride, calcium chloride, oxygen, hydrogen sulfide, carbon dioxide, sulfur dioxide, and the like.

The term “-ene” as used as a suffix as part of another group denotes a bivalent substituent in which a hydrogen atom is removed from each of two terminal carbons of the group, or if the group is cyclic, from each of two different carbon atoms in the ring. For example, alkylene denotes a bivalent alkyl group such as methylene (—CH₂—) or ethylene (—CH₂CH₂—), and arylene denotes a bivalent aryl group such as o-phenylene, m-phenylene, or p-phenylene.

As used herein, the term “exemplary” refers to an example, an instance, or an illustration, and does not indicate a most preferred embodiment unless otherwise stated.

As used herein, the term “fluid source” means any fluid used in oil or gas well production operations that contain one or more corrodents.

The term “generally” encompasses both “about” and “substantially.”

The term “inhibiting” as referred to herein includes inhibiting, preventing, retarding, mitigating, reducing, controlling and/or delaying corrosion on a surface or within a system, namely an oil-field system.

As used herein, the term “injectate” means water plus any solids or liquids dispersed therein that is injected into a subterranean formation for the purpose of inducing hydrocarbon recovery therefrom. Injectates optionally include salts, polymers, surfactants, scale inhibitors, stabilizers, metal chelating agents, corrosion inhibitors, paraffin inhibitors, and other additives as determined by the operator in a subterranean hydrocarbon recovery process.

As used herein, the term “optional” or “optionally” means that the subsequently described component, event or circumstance may but need not be present or occur. The description therefore discloses and includes instances in which the event or circumstance occurs and instances in which it does not, or instances in which the described component is present and instances in which it is not.

As used herein, the term “produced water” means water that flows back from a subterranean reservoir and is collected during a hydrocarbon recovery process including, but not limited to hydraulic fracturing and tertiary oil recovery. Produced water includes residual hydrocarbon products entrained therein and one or more of injectate, connate (native water present in the subterranean formation along with the hydrocarbon), brackish water, and sea water. Produced water ranges in temperature from about −30° C. to about 200° C., depending on the subterranean reservoir and the terranean environment and infrastructure proximal to the subterranean reservoir.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

The term “substituted” as in “substituted aryl,” “substituted alkyl,” and the like, means that in the group in question (i.e., the alkyl, aryl or other group that follows the term), at least one hydrogen atom bound to a carbon atom is replaced with one or more substituent groups such as hydroxy (—OH), alkylthio, phosphino, amido (—CON(R_{A})(R_{B}), wherein R_{A} and R_{B} are independently hydrogen, alkyl, or aryl), amino (—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like. Further, an alkylene group in the chain can be replaced with an ether, an amine, an amide, a carbonyl, an ester, a cycloalkyl, or a heterocyclo functional group. When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Corrosion-Inhibiting Compositions

According to embodiments, the corrosion-inhibiting compositions include from about 1 wt-% to about 50 wt-% of at least one corrosion inhibitor and from about 50 wt-% to about 99 wt-% of at least one solvent comprising paraffinic oil, wherein the paraffinic oil has between about 5-40 wt-% paraffin content. In embodiments the paraffinic oil comprise n-paraffins. In embodiments the paraffinic oil is a linear, aliphatic C9-C20 hydrocarbon. In any of the embodiments additional solvents can be combined with the paraffinic oil while maintaining a total paraffin content in the combined solvents that remains above at least about 5 wt-%. In embodiments the corrosion inhibitor comprises at least one of a fatty acid (or salts) amine condensate, a quaternary ammonium compound, phosphate ester, aromatic amine, organic sulfur compound and/or organic sulfonic acid aminc.

In embodiments the corrosion-inhibiting compositions are described in weight percentages of the compositions. While the components may have a percent active of 100%, it is noted that the percent actives of the components is not defined, but rather, total weight percentage of the raw materials (i.e. active concentration plus inert ingredients) are disclosed. In an exemplary embodiment the corrosion inhibitor(s) comprises from about 1 wt-% to about 50 wt-% of the composition, the solvent(s) comprises from about 50 wt-% to about 99 wt-% of the composition, and the optional additional functional ingredient(s) comprises from about 0 wt-% to about 40 wt-% of the composition. In a further exemplary embodiment the corrosion inhibitor(s) comprises from about 10 wt-% to about 50 wt-% of the composition, the solvent(s) comprises from about 50 wt-% to about 90 wt-% of the composition, and the optional additional functional ingredient(s) comprises from about 0 wt-% to about 35 wt-% of the composition. In a still further exemplary embodiment the corrosion inhibitor(s) comprises from about 20 wt-% to about 50 wt-% of the composition, the solvent comprises from about 50 wt-% to about 80 wt-% of the composition, and the optional additional functional ingredient(s) comprises from about 0 wt-% to about 30 wt-% of the composition.

### Corrosion Inhibitors

The corrosion-inhibiting composition comprises at least one corrosion inhibitor. The term “corrosion inhibitor (or referred to as CI)” refers to a compound or mixture of compounds that prevents, retards, mitigates, reduces, controls and/or delays corrosion. In embodiments the corrosion-inhibiting composition can comprise one or more of a fatty acid (or salts) amine condensate, a quaternary ammonium compound, phosphate ester, aromatic amine, organic sulfur compound, and organic sulfonic acid amine. In embodiments the corrosion-inhibiting composition can comprise a combination of corrosion inhibitors selected from the group consisting of a fatty acid (or salts) amine condensate, a quaternary ammonium compound, phosphate ester, aromatic amine, organic sulfur compound, organic sulfonic acid amine and combinations thereof.

In some embodiments, the corrosion inhibitors are included in the composition at an amount of at least about 1 wt-% to about 75 wt-%, about 1 wt-% to about 50 wt-%, about 5 wt-% to about 50 wt-%, about 10 wt-% to about 50 wt-%, about 15 wt-% to about 50 wt-%, about 20 wt-% to about 50 wt-%, or about 25 wt-% to about 50 wt-%. In addition, without being limited according to the disclosure, all ranges recited are inclusive of the numbers defining the range and include each integer within the defined range.

### Fatty Acid Amine Condensates

In embodiments the corrosion-inhibiting composition includes a fatty acid (or salt) amine condensate corrosion inhibitor. Fatty acid amine condensates includes, for example, salts of a fatty acid amine condensates, amides, imidazolines, and imidazoline derivatives including imidazolinium compounds.

Fatty acid amine condensates are the reaction products produced by reacting fatty acids with amines. Any amine may be used, and any fatty acid may be used. Illustrative, non-limiting examples of fatty acids are carboxylic acids with long hydrocarbon chains, the hydrocarbon chains generally having from about 10 to about 30 carbon atoms. The fatty acids may be both saturated and unsaturated.

Exemplary salts of fatty acid amine condensates can include for example, carboxylic acid-polyamine condensates, carboxylic acid alkanolamine salts, such as dicarboxylic acid diethanolamine salts, and reaction products of (1) a polyunsaturated fatty acid dimer, (2) a sulfonic acid compound, and (3) a reaction product of a polyalkylene polyamine, a tall oil fatty acid, and a polyunsaturated fatty acid dimer. A preferred salt of a fatty acid amine condensate is commercially available as tall oil acid, dimeric linoleic acid, poly C2-C4 alkylene polyamine condensate, dodecylbenzene sulfonic acid, dimeric linoleic acid salts (CAS 68910-85-0).

In embodiments where the salts of fatty acid amine condensates are carboxylic acid-polyamine condensates, examples include naphthenic acid reaction products with Diethylenetriamine and Tall Oil Fatty Acids. These also include imidazolines.

In embodiments where the salts of fatty acid amine condensates are carboxylic acid alkanolamine salts, which can include substituted aromatic amine can comprise an alkyl pyridine such as 3,5-diethyl-2-methylpyridine or 3-ethyl-4-methylpyridine, or other substituted pyridines such as (E)-5-ethyl-2-(prop-1-en-1-yl) pyridine, (E)-5-(but-2-en-1-yl)-2-methylpyridine, or N-ethyl-2-(6-methylpyridin-3-yl) ethanamine. An example employed in compositions described herein this disclosure include dicarboxylic acid diethanolamine salts, such as 2-cyclohexene-1-octanoic acid, 5(or 6)-carboxy-4-hexyl-, compd. with 2,2′iminobis(ethanol).

In embodiments where the salts of fatty acid amine condensates are a reaction product of (1) a polyunsaturated fatty acid dimer, (2) a sulfonic acid compound, and (3) a reaction product of a polyalkylene polyamine, a tall oil fatty acid, and a polyunsaturated fatty acid dimer, the polyunsaturated fatty acid dimer (or the polyunsaturated fatty acid dimer of the reaction product (3) above) can independently comprise a dimer of linoleic acid, gamma-linolenic acid (GLA), cicosadienoic acid, dihomo-gamma-linolenic acid (DLGA), arachidonic acid (AA), docosadienoic acid, adrenic acid, docosapentaenoic acid, tetracosatetraenoic acid, tetracosapentaenoic acid, hexadecatrienoic acid (HTA), alpha-linolenic acid (ALA), stearidonic acid (SDA), cicosatrienoic acid (ETE), eicosatetraenoic acid (ETA), cicosapentaenoic acid (EPA), heneicosapentaenoic acid (HPA), docosapentaenoic acid (DPA), docosahexaenoic acid (DHA), tetracosapentaenoic acid, tetracosahexaenoic acid, mead acid, or a combination thereof. Preferably, the polyunsaturated fatty acid dimer comprises linoleic acid dimer.

The sulfonic acid compound can comprise organic sulfonic acid. Organic sulfonic acid can be an aryl sulfonic acid including, but not limited to, a linear alkylbenzenesulfonic acid, a branched alkylbenzenesulfonic acid, or other substituted or unsubstituted aromatic sulfonic acid. Suitable aryl sulfonic acids include, but are not limited to, methylbenzene sulfonic acid (e.g., p-toluenesulfonic acid), ethylbenzene sulfonic acid, butylbenzene sulfonic acid, octylbenzene sulfonic acid, dodecylbenzene sulfonic acid, and 2-naphthalene sulfonic acid. Preferably, the sulfonic acid compound comprises a linear alkyl benzene sulfonic acid such as dodecylbenzene sulfonic acid.

Organic sulfonic acid can also comprise an alkyl sulfonic acid or an arylalkyl sulfonic acid including, but not limited to methanesulfonic acid, trifluoromethanesulfonic acid, DL-camphorsulfonic acid, and phenylmethanesulfonic acid.

Organic sulfonic acid can include a monosulfonic acid, a disulfonic acid, or a polysulfonic acid. Suitable disulfonic acids include, but are not limited to, benzenedisulfonic acid, napthalenedisulfonic acid, 2,3-dimethyl-1,4-benzenedisulfonic acid, 2,4-dimethyl-1,3-benzenedisulfonic acid, 2,5-dimethyl-1,3-benzenedisulfonic acid, 2,5-dimethyl-1,4-benzenedisulfonic acid, 3,6-dimethyl-1,2-benzenedisulfonic acid, or a combination thereof. Suitable polysulfonic acids include, but are not limited to, benzene trisulfonic acid, naphthalene trisulfonic acid, 1,3,6-napthalenetrisulfonic acid, 1-nitronaphthalene-3,6,8-trisulfonic acid, or a combination thereof.

The polyalkylene polyamine of the reaction product (3) above can include, but is not limited to, a polyethylene polyamine, a polypropylene polyamine, a polybutylene polyamine, and a combination thereof. Preferably, the polyalkylene polyamine comprises a combination of polyethylene polyamine, polypropylene polyamines, and polybutylene polyamines.

Suitable polyethylene polyamines include, but are not limited to, diethylene triamine (DETA), triethylene tetramine (TETA), tetraethylene pentamine (TEPA), pentaethylene hexamine (PEHA), hexaethylene heptamine (HEHA), and higher homologues.

Suitable polypropylene polyamines include, but are not limited to, dipropylene triamine, tripropylene tetramine, tetrapropylene pentamine, pentapropylene hexamine, hexapropylene heptamine, and higher homologues.

Suitable polybutylene polyamines include, but are not limited to, dibutylene triamine, tributylene tetramine, tetrabutylene pentamine, pentabutylene hexamine, hexabutylene heptamine, and higher homologues.

Other suitable polyalkylene polyamines include bis(hexamethylene)triamine, N,N′-bis(3-aminopropyl) ethylenediamine, spermidine, and sperminc.

It will be recognized by those skilled in the art that polyalkylene polyamines containing four or more nitrogen atoms are generally available as mixtures of linear, branched, and cyclic compounds, most of which contain the same number of nitrogen atoms. For example, triethylene tetramine (TETA) contains not only linear TETA, but also tris(aminoethyl)amine, N,N′-bis(2-aminoethyl)piperazine, and N-[(2-aminoethyl)-2-aminoethyl]piperazine. Similarly, tetraethylene pentamine is principally a mixture of four TEPA ethyleneamines, including linear, branched, and two cyclic TEPA products.

A suitable polyalkylene polyamine is Ethyleneamine E-100, a commercially available mixture of polyethylene polyamines comprising TEPA, PEHA, and HEHA (Huntsman Corporation). Ethyleneamine E-100 typically consists of less than 1.0 wt-% of low molecular weight amine, 10-15 wt-% TEPA, 40-50 wt-% PEHA, and the balance HEHA and higher oligomers. Typically, Ethyleneamine E-100 has total nitrogen content of about 33-34 wt-% and a number average molecular weight of 250-300 g/mole.

A suitable polyamine mixture is Heavy Polyamine X (HPA-X), commercially available from Dow Chemical Company. Heavy Polyamine X is a complex mixture of linear, branched, and cyclic polyethylene polyamines, comprising TETA, TEPA, PEHA, and polyethylene polyamines (CAS No. 68131-73-7 or CAS No. 29320-38-5).

Another suitable polyamine mixture is Amix 1000 (CAS #68910 May 4), commercially available from BASF Corporation. Amix 1000 is a mixture of roughly equivalent amounts of aminoethylethanolamine, triethylene tetramine (TETA), aminoethylpiperazine, and high boiling polyamines.

The tall oil fatty acid of the reaction product (3) above can comprise any tall oil fatty acid including, but not limited to, oleic acid, linoleic acid, abietic acid, neoabietic acid, palustric acid, pimaric acid, dehydroabietic acid, palmitic acid, stearic acid, palm itoleic acid, 5,9,12-octadecatrienoic acid, linolenic acid, 5,II,14-eicosatrenoic acid, cis,cis-5,9-octadecadienoic acid, eicosadienoic acid, elaidic acid, cis-11-octadecanoic acid, or a combination thereof, as well as other C₂₀, C₂₂, C₂₄ saturated acids.

Exemplary imidazolines can be, for example, imidazoline derived from a diamine, such as ethylene diamine (EDA), diethylene triamine (DETA), triethylene tetraamine (TETA), aminoethylethanolamine (AEEA), tetraethylenepentamine (TEPA), etc. and a long chain fatty acid such as tall oil fatty acid (TOFA). These can be further reacted with various acids including acetic, acrylic, etc. The imidazoline can be an imidazoline of Formula (I) or an imidazoline derivative.

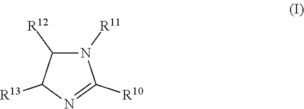

wherein R¹⁰ is a C₁-C₂₀ alkyl or a C₁-C₂₀ alkoxyalkyl group; R¹¹ and R¹⁴ are independently hydrogen, C₁-C₆ alkyl, C₁-C₆ hydroxyalkyl, or C₁-C₆ arylalkyl; R¹² and R¹³ are independently a C₁-C₆ alkyl group or hydrogen. An exemplary imidazolinium salt includes 1-benzyl-1-(2-hydroxyethyl)-2-tall-oil-2-imidazolinium chloride. A further exemplary imidazoline includes an R¹⁰ which is the alkyl mixture typical in tall oil fatty acid (TOFA), and R¹¹, R¹² and R¹³ are each hydrogen.

Representative imidazoline derivatives include an imidazolinium compound of Formula (II) or a bis-quaternized compound of Formula (III), each shown below:

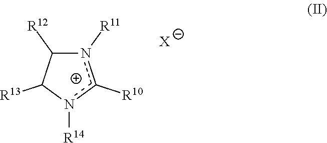

wherein R¹⁰ is a C₁-C₂₀ alkyl or a C₁-C₂₀ alkoxyalkyl group; R¹¹ and R¹⁴ are independently hydrogen, C₁-C₆ alkyl, C₁-C₆ hydroxyalkyl, or C₁-C₆ arylalkyl; R¹² and R¹³ are independently hydrogen or a C₁-C₆ alkyl group; and X-is a halide (such as chloride, bromide, or iodide), carbonate, sulfonate, phosphate, or the anion of an organic carboxylic acid (such as acetate). Preferably, the imidazolinium compound includes 1-benzyl-1-(2-hydroxyethyl)-2-tall-oil-2-imidazolinium chloride. Exemplary corrosion inhibitors can include wherein R¹⁰ is the alkyl mixture typical in tall oil fatty acid (TOFA), and R¹¹, R¹² and R¹³ are each hydrogen.

Preferably, the imidazolinium compound includes 1-benzyl-1-(2-hydroxyethyl)-2-tall-oil-2-imidazolinium chloride, or

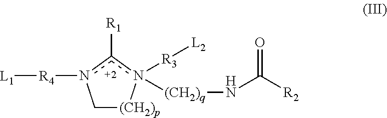

wherein: R¹, R², R³ and R⁴ are independently selected from the group consisting of unsubstituted branched, chain or ring alkyl or alkenyl having from 1 to about 29 carbon atoms; partially or fully oxygenized, sulfurized, and/or phosphorylized branched, chain, or ring alkyl or alkenyl having from 1 to about 29 carbon atoms; or a combination thereof; L₁ and L₂ are each independently selected from the group consisting of —H, —COOH, —SO₃H, —PO₃H₂, —COOR₄, —CONH₂, —CONHR₄, —CON(R₄)₂, and combinations thereof; and p is from 1 to about 5, and q is from 1 to about 10.

An exemplary imidazolinium compound includes 1-benzyl-1-(2-hydroxyethyl)-2-tall-oil-2-imidazolinium chloride, or the compound of formula IV:

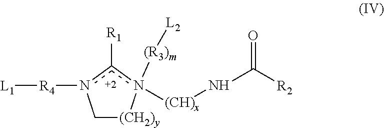

wherein: R₁ and R₂ are each independently unsubstituted branched, chain or ring alkyl or alkenyl having from 1 to about 29 carbon atoms; partially or fully oxygenized, sulfurized, and/or phosphorylized branched, chain, or ring alkyl or alkenyl having from 1 to about 29 carbon atoms; or a combination thereof; R₃ and R₄ are each independently unsubstituted branched, chain or ring alkylene or alkenylene having from 1 to about 29 carbon atoms; partially or fully oxygenized, sulfurized, and/or phosphorylized branched, chain, or ring alkylene or alkenylene having from 1 to about 29 carbon atoms; or a combination thereof; L₁ and L₂ are each independently absent, H, —COOH, —SO₃H, —PO₃H₂, —COOR₅, —CONH₂, —CONHR₅, or —CON(R₅)₂; R₅ is each independently a branched or unbranched alkyl, aryl, alkylaryl, alkylheteroaryl, cycloalkyl, or heteroaryl group having from 1 to about 10 carbon atoms; n is 0 or 1, and when n is 0, L₂ is absent or H; x is from 1 to about 10; and y is from 1 to about 5.

In some embodiments of formulae III and IV, preferably, R₁ and R₂ are each independently C₆-C₂₂ alkyl, C₈-C₂₀ alkyl, C₁₂-C₁₈ alkyl, C₁₆-C₁₈ alkyl, or a combination thereof; R₃ and R₄ are C₁-C₁₀ alkylene, C₂-C₈ alkylene, C₂-C₆ alkylene, or C₂-C₃ alkylene; n is 0 or 1; x (or q) is 2; y (or q) is 1; R₃ and R₄ are-C₂H₂-; L₁ is —COOH, —SO₃H, or —PO₃H₂; and L₂ is absent, H, —COOH, —SO₃H, or —PO₃H₂. For example, R₁ and R₂ can be derived from a mixture of tall oil fatty acids and are predominantly a mixture of C₁₇H₃₃ and C₁₇H₃₁ or can be C₁₆-C₁₈ alkyl; R₃ and R₄ can be C₂-C₃ alkylene such as —C₂H₂—; n is 1 and L₂ is —COOH or n is 0 and L₂ is absent or H; x is 2; y is 1; R₃ and R₄ are —C₂H₂—; and L₁ is —COOH.

The imidazoline corrosion inhibitor can comprise a bis-quaternized imidazoline compound having the formula (IV) wherein R₁ and R₂ are each independently C₆-C₂₂ alkyl, C₈-C₂₀ alkyl, C₁₂-C₁₈ alkyl, or C₁₆-C₁₈ alkyl or a combination thereof; R₄ is C₁-C₁₀ alkylene, C₂-C₈ alkylene, C₂-C₆ alkylene, or C₂-C₃ alkylene; x is 2; y is 1; n is 0; L₁ is —COOH, —SO₃H, or —PO₃H₂; and L₂ is absent or H. Preferably, a bis-quaternized compound has the formula (III) wherein R₁ and R₂ are each independently C₁₆-C₁₈ alkyl; R₄ is —C₂H₂—; x is 2; y is 1; n is 0; L₁ is —COOH, —SO₃H, or —PO₃H₂ and L₂ is absent or H.

In some embodiments, the fatty acid (or salts) amine condensate is included in the composition at an amount of at least about 1 wt-% to about 75 wt-%, about 1 wt-% to about 50 wt-%, about 5 wt-% to about 50 wt-%, about 10 wt-% to about 50 wt-%, about 15 wt-% to about 50 wt-%, about 20 wt-% to about 50 wt-%, or about 25 wt-% to about 50 wt-%. In addition, without being limited according to the disclosure, all ranges recited are inclusive of the numbers defining the range and include each integer within the defined range.

### Quaternary Ammonium Compounds

In embodiments the corrosion-inhibiting composition includes a quaternary ammonium compound corrosion inhibitor. Illustrative, non-limiting examples of suitable quaternary ammonium compounds are selected from benzyldimethyldodecylammonium chloride, benzyldimethyltetradecylammonium chloride, benzyldimethylhexadecylammonium chloride, benzyldimethyloctadecyl ammonium chloride, and any combination thereof.

Quaternary ammonium compounds can have the following Formula (V):

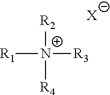

(V) wherein R₁, R₂, and R₃ are independently C to C₂₀ alkyl, R₄ is methyl or benzyl, and X⁻ is a halide or methosulfate.

Suitable alkyl, hydroxyalkyl, alkylaryl, arylalkyl or aryl amine quaternary salts include those alkylaryl, arylalkyl and aryl amine quaternary salts of the formula [N⁺R^{5a}R^{6a}R^{7a}R^{8a}][X⁻] wherein R^{5a}, R^{6a}, R^{7a}, and R^{8a} contain one to 18 carbon atoms, and X is Cl, Br or I. For the quaternary salts, R^{5a}, R^{6a}, R^{7a}, and R^{8a} can each be independently alkyl (e.g., C₁-C₁₈ alkyl), hydroxyalkyl (c.g., C₁-C₁₈ hydroxyalkyl), and arylalkyl (e.g., benzyl). The mono or polycyclic aromatic amine salt with an alkyl or alkylaryl halide include salts of the formula [N⁺R^{5a}R^{6a}R^{7a}R^{8a}][X⁻] wherein R^{5a}, R^{6a}, R^{7a}, and R^{8a} contain one to 18 carbon atoms and at least one aryl group, and X is Cl, Br or I.

Suitable quaternary ammonium salts include, but are not limited to, a tetramethyl ammonium salt, a tetraethyl ammonium salt, a tetrapropyl ammonium salt, a tetrabutyl ammonium salt, a tetrahexyl ammonium salt, a tetraoctyl ammonium salt, a benzyltrimethyl ammonium salt, a benzyltriethyl ammonium salt, a phenyltrimethyl ammonium salt, a phenyltriethyl ammonium salt, a cetyl benzyldimethyl ammonium salt, a hexadecyl trimethyl ammonium salt, a dimethyl alkyl benzyl quaternary ammonium salt, a monomethyl dialkyl benzyl quaternary ammonium salt, or a trialkyl benzyl quaternary ammonium salt, wherein the alkyl group has about 6 to about 24 carbon atoms, about 10 and about 18 carbon atoms, or about 12 to about 16 carbon atoms. The quaternary ammonium salt can be a benzyl trialkyl quaternary ammonium salt, a benzyl triethanolamine quaternary ammonium salt, or a benzyl dimethylaminoethanolamine quaternary ammonium salt.

The quaternary ammonium CIs can comprise a pyridinium salt such as those represented by Formula (VI):

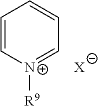

(VI) wherein R⁹ is an alkyl group, an aryl group, or an arylalkyl group, wherein said alkyl groups have from 1 to about 18 carbon atoms and X⁻ is a halide such as chloride, bromide, or iodide. Among these compounds are alkyl pyridinium salts and alkyl pyridinium benzyl quats. Exemplary compounds include methyl pyridinium chloride, ethyl pyridinium chloride, propyl pyridinium chloride, butyl pyridinium chloride, octyl pyridinium chloride, decyl pyridinium chloride, lauryl pyridinium chloride, cetyl pyridinium chloride, benzyl pyridinium chloride and an alkyl benzyl pyridinium chloride, preferably wherein the alkyl is a C₁-C₆ hydrocarbyl group. Preferably, the pyridinium compound includes benzyl pyridinium chloride.

In some embodiments, the quaternary ammonium compound is included in the composition at an amount of at least about 1 wt-% to about 75 wt-%, about 1 wt-% to about 50 wt-%, about 5 wt-% to about 50 wt-%, about 10 wt-% to about 50 wt-%, about 15 wt-% to about 50 wt-%, about 20 wt-% to about 50 wt-%, or about 25 wt-% to about 50 wt-%. In addition, without being limited according to the disclosure, all ranges recited are inclusive of the numbers defining the range and include each integer within the defined range.

### Phosphate Esters

In embodiments the corrosion-inhibiting composition includes phosphate ester corrosion inhibitor. Exemplary phosphate esters include, for example mono-, di- and tri-alkyl as well as alkylaryl phosphate esters and phosphate esters of mono, di, and triethanolamine typically contain between from 1 to about 18 carbon atoms. Preferred mono-, di- and trialkyl phosphate esters, alkylaryl or arylalkyl phosphate esters are those prepared by reacting a C₃-C₁₈ aliphatic alcohol with phosphorous pentoxide. The phosphate intermediate interchanges its ester groups with tricthylphosphate producing a broader distribution of alkyl phosphate esters.

Alternatively, the phosphate ester can be made by admixing with an alkyl diester, a mixture of low molecular weight alkyl alcohols or diols. The low molecular weight alkyl alcohols or diols preferably include C₆ to C₁₀ alcohols or diols. Further, phosphate esters of polyols and their salts containing one or more 2-hydroxyethyl groups, and hydroxylamine phosphate esters obtained by reacting polyphosphoric acid or phosphorus pentoxide with hydroxylamines such as diethanolamine or triethanolamine are preferred.

In some embodiments, the phosphate ester is included in the composition at an amount of at least at least about 1 wt-% to about 75 wt-%, about 1 wt-% to about 50 wt-%, about 5 wt-% to about 50 wt-%, about 10 wt-% to about 50 wt-%, about 15 wt-% to about 50 wt-%, about 20 wt-% to about 50 wt-%, or about 25 wt-% to about 50 wt-%. In addition, without being limited according to the disclosure, all ranges recited are inclusive of the numbers defining the range and include each integer within the defined range.

### Aromatic Amines

In embodiments the corrosion-inhibiting composition includes an amine, including for example aromatic amines, aliphatic amines, heterocyclic amines or alkoxylated amines, amidoamines, quaternary amines and the like, as a corrosion inhibitor. In preferred embodiments the amine is an aromatic amine. Exemplary aromatic amines comprise a pyridine or quinoline.

In some embodiments, the aromatic amine is included in the composition at an amount of at least about 1 wt-% to about 75 wt-%, about 1 wt-% to about 50 wt-%, about 5 wt-% to about 50 wt-%, about 10 wt-% to about 50 wt-%, about 15 wt-% to about 50 wt-%, about 20 wt-% to about 50 wt-%, or about 25 wt-% to about 50 wt-%. In addition, without being limited according to the disclosure, all ranges recited are inclusive of the numbers defining the range and include each integer within the defined range.

Organic Sulfur Compound and/or Organic Sulfonic Acid Amine

In embodiments the corrosion-inhibiting composition includes an organic sulfur compound and/or organic sulfonic acid amine corrosion inhibitor. Organic sulfur compounds include for example, mercaptoalkyl alcohol, mercaptoacetic acid, thioglycolic acid, 3,3′-dithiodipropionic acid, thiosulfate, thiourea, L-cysteine, tert-butyl mercaptan, sodium thiosulfate, ammonium thiosulfate, sodium thiocyanate, ammonium thiocyanate, sodium metabisulfite, or a combination thereof. Preferably, the mercaptoalkyl alcohol comprises 2-mercaptocthanol.

Organic sulfonic acid amines include for example, alkyl or aryl sulfonic acid amines, or salts thereof, such as morpholine dodecylbenzenesulfonate.

In some embodiments, the organic sulfur compound and/or organic sulfonic acid amine is included in the composition at an amount of at least about 0.1 wt-% to about 50 wt-%, about 0.1 wt-% to about 20 wt-%, about 0.1 wt-% to about 15 wt-%, about 1 wt-% to about 10 wt-%, about 1 wt-% to about 8 wt-%, or about 2 wt-% to about 8 wt-%. In addition, without being limited according to the disclosure, all ranges recited are inclusive of the numbers defining the range and include each integer within the defined range.

### Solvent

The compositions include a solvent comprising paraffinic oil, wherein the paraffinic oil has at least about 5 wt-% paraffin content or between about 5 wt-% and about 40 wt-% paraffin content. Paraffins are a group of alkanes (saturated hydrocarbons with the formula CₙH₂ₙ₊₂ where n is a whole number). Alkane is the IUPAC name for a class of hydrocarbons that are frequently referred to as “paraffin hydrocarbons” or “paraffins”. Paraffin content refers to the measured amount of paraffin in an overall hydrocarbon solvent, often referred to as resolved n-paraffins. For example, in embodiments described herein the paraffinic oil has at least about 5 wt-% paraffinic oil or between about 5-40 wt-% paraffinic oil in the hydrocarbon solvent, which is herein referred to as the paraffin content.

As referred to herein, the paraffinic oil has at least about 5 wt-% paraffin content, or between about 5-40 wt-% paraffin content. In some embodiments the paraffinic oil is a high paraffinic oil having at least about 20 wt-% paraffin content.

In embodiments the paraffinic oil comprises n-paraffins. In embodiments the paraffinic oil comprises linear, aliphatic C9-C20 hydrocarbons. In further embodiments the paraffinic oil comprises n-paraffins and linear, aliphatic C9-C20 hydrocarbon structures with between about 5-40 wt-% paraffin content. Without being limited to a mechanism of action of the corrosion-inhibiting compositions, the paraffinic oil solvents having the aliphatic hydrocarbon chains enhance the performance of corrosion inhibitors bound to a surface in need of corrosion inhibition by extending the separation of fluids from the surface by binding to the hydrocarbon tails of various corrosion inhibitors to enhance corrosion inhibition and metal wear loss by providing enhanced corrosion inhibitor performance and persistency.

In some embodiments more than one solvent is included in the compositions such that the total solvent concentration in the corrosion-inhibiting composition provides at least about 5 wt-% paraffin content. For example, additional solvents combined with the paraffinic oil can include an organic solvents, aromatic solvents, and water. In some embodiments the additional solvent can include organic solvents including additional hydrocarbons different from the paraffinic oils. Without being limited to a particular mechanism of action, the paraffinic oils including those linear, aliphatic C9-C20 hydrocarbon structure with between about 5-40 wt-% paraffin content provide significant benefits for corrosion-inhibiting compositions distinct from other hydrocarbon solvents, including for example paraffins such as cyclohexanes and heptanes which have respectively ring structures and shorter aliphatic chains. Benefit of corrosion inhibition improvements are achieved in solvent systems comprising at least about 5 wt-% paraffin content.

In embodiments the solvent comprising at least about 5 wt-% paraffin content or between about 5 wt-% and about 40 wt-% paraffin content, or a solvent system having at least about 5 wt-% paraffin content is a solvent and the paraffin is not a reaction product within a composition or an aqueous system (e.g. aminoparaffins or chloro paraffins such as hydrochloric acid aminoparaffins).

Exemplary additional solvents include organic solvents including an alcohol, a hydrocarbon, a ketone, an ether, an alkylene glycol, a glycol ether, an amide, a nitrile, a sulfoxide, an ester, or a combination thereof. Examples of suitable organic solvents include, but are not limited to, methanol, ethanol, propanol, isopropanol, butanol, 2-ethylhexanol, hexanol, octanol, decanol, 2-butoxyethanol, glycols and derivatives (ethylene glycol, methylene glycol, 1,2-propylene glycol, 1,3-propylene glycol, diethyleneglycol monomethyl ether, cthylene glycol monobutyl ether, ethylene glycol dibutyl ether, etc.), pentane, hexane, cyclohexane, methylcyclohexane, heptane, decane, dodecane, diesel, toluene, xylene, heavy aromatic naphtha, cyclohexanone, diisobutylketone, diethyl ether, propylene carbonate, N-methylpyrrolidinone, N,N-dimethylformamide, or a combination thereof.

Exemplary additional solvents include aromatic solvents including aromatic hydrocarbons such as toluene, xylene, heavy aromatic naphtha, or a combination thereof.

Preferably, the aromatic solvent comprises heavy aromatic naphtha or xylene. In any of the embodiments described the aromatic solvent(s) is preferably combined with water.

Exemplary additional solvents include one or more solvents selected from the group consisting of xylene, isopropanol, methanol, ethanol, 2-ethylhexanol, heavy aromatic naphtha, toluene, ethylene glycol, ethylene glycol monobutyl ether (EGMBE), diethylene glycol monocthyl ether, water, and any combination thereof.

In some embodiments, the solvent(s) (including the paraffinic oil and optionally additional solvent(s)) is included in the composition at an amount of at least about 25 wt-% to about 99 wt-%, about 30 wt-% to about 99 wt-%, about 40 wt-% to about 99 wt-%, about 50 wt-% to about 99 wt-%, about 50 wt-% to about 90 wt-%, about 50 wt-% to about 85 wt-%, about 50 wt-% to about 80 wt-%, or about 50 wt-% to about 75 wt-%. In addition, without being limited according to the disclosure, all ranges recited are inclusive of the numbers defining the range and include each integer within the defined range.

### Additional Functional Ingredients

The corrosion-inhibiting compositions can further be combined with various additional functional components suitable for uses disclosed herein. In some embodiments, the compositions including the corrosion inhibitor(s) and solvent comprising a paraffinic oil that make up a large amount, or even substantially all of the total weight of the compositions. For example, in some embodiments few or no additional functional ingredients are disposed therein. In some embodiments, the composition comprises, consists essentially of, or consists of the corrosion inhibitor(s) and solvent comprising a paraffinic oil. In some embodiments the compositions and methods of using the compositions do not include a scale inhibitor.

In other embodiments, additional functional ingredients may be included in the compositions. The functional ingredients provide desired properties and functionalities to the compositions. For the purpose of this application, the term “functional ingredient” includes a material that when dispersed or dissolved in the use and/or concentrate compositions described herein provides a beneficial property in a particular use.

In some embodiments, the compositions may include additional corrosion inhibitors, surfactants, corrosion inhibitor intensifiers, pH control additives, surfactants, bactericides, biocides, defoamers, demulsifiers, friction reducers, drag reducing agents, flow improvers, viscosity reducers, sulfur compounds, or any combinations thereof. Exemplary types of the various additional functional ingredients is included in U.S. Pat. No. 11,242,480, which is incorporated by reference in its disclosure of the various listings of additional functional ingredients.

In further embodiments, the composition may include at least one additional component selected from the group consisting of corrosion inhibitors, surfactants, corrosion inhibitor intensifiers, pH control additives, surfactants, bactericides, biocides, defoamers, demulsifiers, friction reducers, drag reducing agents, flow improvers, viscosity reducers, sulfur compounds, and combinations thereof.

According to embodiments of the disclosure, the various additional functional ingredients may be provided in a composition in the amount from about 0 wt-% and about 40 wt-%, from about 0 wt-% and about 30 wt-%, from about 0 wt-% and about 20 wt-%, from about 0.01 wt-% and about 40 wt-%, from about 0.1 wt-% and about 40 wt-%, from about 0.1 wt-% and about 30 wt-%, from about 0.1 wt-% and about 20 wt-%, or from about 1 wt-% and about 20 wt-%, from about 0.1 wt-% and about 10 wt-%, or from about 1 wt-% and about 10 wt-%. In addition, without being limited according to the disclosure, all ranges recited are inclusive of the numbers defining the range and include cach integer within the defined range. Additional examples of additional functional ingredients are listed herein as exemplary wt-% ranges based on the total weight of the compositions, in addition these weight percentage ranges.

The compositions can optionally include additional corrosion inhibitors. An exemplary additional corrosion inhibitor includes for example carboxylic acids. Carboxylic acids include organic acids having carboxyl group attached to an R-group (R-COOH). In some embodiments, the carboxylic acid is a fatty acid, such as monomeric or oligomeric fatty acid. Exemplary monomeric or oligomeric fatty acids can include saturated and unsaturated fatty acids as well as dimer, trimer and oligomer products obtained by polymerizing one or more of such fatty acids. Additional optional corrosion inhibitors include alkanolamines or salts thereof. Exemplary alkanolamines or salts thereof can include for example, fatty acid alkanolamines, fatty acid ethanolamines, fatty acid diethanolamines or triethanolamines, such as dicarboxylic acid diethanolamines, and salts thereof.

The compositions can optionally include corrosion inhibitor intensifiers, also referred to as an additive that enhances the performance of corrosion inhibition. Suitable intensifiers may include, but are not limited to, carboxylic acid compounds having 1 to 12 carbon atoms or an ester (including protected carboxylic acid derivatives) or salt thereof, quaternary ammonium compounds, thiol chemistries and others when used in combination with a corrosion inhibitor.

The compositions can optionally include a pH control additive. Suitable pH control additives include, but are not limited to, alkali hydroxides, alkali carbonates, alkali bicarbonates, alkaline earth metal hydroxides, alkaline earth metal carbonates, alkaline earth metal bicarbonates and mixtures or combinations thereof. Exemplary pH modifiers include sodium hydroxide, potassium hydroxide, calcium hydroxide, calcium oxide, sodium carbonate, potassium carbonate, sodium bicarbonate, potassium bicarbonate, magnesium oxide, and magnesium hydroxide.

The compositions can optionally include a surfactant. Suitable surfactants include, but are not limited to, anionic surfactants and nonionic surfactants. Anionic surfactants include alkyl aryl sulfonates, olefin sulfonates, paraffin sulfonates, alcohol sulfates, alcohol ether sulfates, alkyl carboxylates and alkyl ether carboxylates, and alkyl and ethoxylated alkyl phosphate esters, and mono and dialkyl sulfosuccinates and sulfosuccinamates. Nonionic surfactants include alcohol alkoxylates, alkylphenol alkoxylates, block copolymers of ethylene, propylene and butylene oxides, alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, alkyl polyglucosides, polyalkoxylated glycerides, sorbitan esters and polyalkoxylated sorbitan esters, and alkoyl polyethylene glycol esters and diesters. Also included are betaines and sultanes, amphoteric surfactants such as alkyl amphoacetates and amphodiacetates, alkyl amphopropionates and amphodipropionates, and alkyliminodipropionate.

The compositions can optionally include a bacteriocide and/or biocide. Suitable examples include, but are not limited to, oxidizing and non-oxidizing biocides. Suitable non-oxidizing biocides include, for example, aldehydes (e.g., formaldehyde, glutaraldehyde, and acrolein), amine-type compounds (e.g., quaternary amine compounds and cocodiamine), halogenated compounds (e.g., 2-bromo-2-nitropropane-3-diol (Bronopol) and 2-2-dibromo-3-nitrilopropionamide (DBNPA)), sulfur compounds (e.g., isothiazolone, carbamates, and metronidazole), and quaternary phosphonium salts (e.g., tetrakis(hydroxymethyl)-phosphonium sulfate (THPS)). Suitable oxidizing examples include, for example, sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, and peroxides.

The compositions can optionally include a demulsifier. An exemplary demulsifier comprises an oxyalkylate polymer, such as a polyalkylene glycol. The demulsifier can be included in the compositions from about 0.5 to about 5 wt-% of the composition, based on total weight of the composition.

The compositions can optionally include a dispersant. Suitable dispersants include, but are not limited to, aliphatic phosphonic acids with 2-50 carbons, such as hydroxyethyl diphosphonic acid, and aminoalkyl phosphonic acids, e.g. polyaminomethylene phosphonates with 2-10 N atoms e.g. cach bearing at least one methylene phosphonic acid group; examples of the latter are ethylenediamine tetra (methylene phosphonate), diethylenetriamine penta (methylene phosphonate), and the triamine-and tetramine-polymethylene phosphonates with 2-4 methylene groups between each N atom, at least 2 of the numbers of methylene groups in cach phosphonate being different. Other suitable dispersion agents include lignin, or derivatives of lignin such as lignosulfonate and naphthalene sulfonic acid and derivatives. The dispersant can be included in the compositions from about 0.1 to about 10 wt-% of the composition, based on total weight of the composition.

### Methods of Use

The corrosion-inhibiting compositions are provided to a system in need of effective corrosion control in the presence of corrodents. The methods of using the corrosion-inhibiting compositions provide improved corrosion inhibition performance and persistency, thereby beneficially increasing the lifespan of the corrosion-inhibiting composition. Without being limited to a particular mechanism of action the corrosion-inhibiting compositions delivering the corrosion inhibitors with a solvent comprising paraffinic oil as described herein increases the corrosion inhibition performance by improving the persistency of the corrosion inhibitors on the treated surface. The paraffinic oil provides an aliphatic hydrocarbon (oil) that can further enhance the corrosion inhibition and film persistency of the corrosion inhibitor compositions applied to a surface. The presence of a film from the aliphatic hydrocarbon (oil) on a treated surface can beneficially provide lubrication and improve wear and friction which beneficially reduces wear with the addition of the film to reduce the wear and friction between moving surfaces, e.g. case tubing and casing, in contact with each other. This beneficially results in aiding in the reduction of the metal wear of a metal surface, and beneficially provides improved reduction of the metal wear beyond the capabilities that would be achieved by use of a corrosion inhibitor alone. As a result, the corrosion-inhibiting compositions beneficially provide both the corrosion inhibition and metal wear reduction.

It can be envisioned based on the description contained herein that the basic structure of a corrosion inhibitor having a heteroatom or high electron density head that adsorbs to a metal surface and hydrocarbon tail is combined with the paraffinic oil having a high paraffinic content of at least about 5% or between about 5% to about 40% which further provides an aliphatic hydrocarbon tail to orientate away from the treated surface to provide an oil wet that repels water from the metal surface. The corrosion-inhibiting compositions combining corrosion inhibitors and the paraffinic oil solvent enhance the tail length to provide improved corrosion inhibition.

The corrosion-inhibiting compositions can be provided in a single composition to a liquid system. In referring to compositions, the scope of the methods of using disclosure also includes combining more than one input (i.e. composition) for the treatment of the liquid system in need of corrosion inhibition. In preferred embodiments a single composition provides the corrosion inhibitor(s) and solvent comprising the paraffinic oil.

The methods apply the compositions to a fluid to prevent, reduce or mitigate corrosion. The mils penetration per year or milli-inch (one thousandth of an inch) (mpy) is used as an estimated general corrosion rate as it refers to the metal thickness lost in the corrosion process per year. 1 mm y⁻¹ equates to about 40 mpy. The MPY is calculated from the following equation:

$$MPY = ( Δ M [ g ] \cdot C ) / ( ρ [ \frac{g}{{cm}^{2}} ] \cdot A [ {in}^{2} ] \cdot t [ hr ] )$$

where ΔM is the mass loss of the coupon at the end of the test in grams, C is a constant equal to 534000, ρ is the density of the coupon in g/cm², A is the surface area of the coupon in cm², and t is the exposure time in hours. In an embodiment, the corrosion inhibiting compositions provide a reduction in corrosion measured by a milli-inches per year (mpy).

In embodiments, the corrosion-inhibiting composition provides at least about a 25% improvement, or at least about a 50% improvement, in corrosion inhibition and/or wear metal loss rate in comparison to a composition without the solvent comprising the paraffinic oil, or in comparison to a composition with only non-paraffinic hydrocarbon solvents.

The methods may be applied to fluid systems or into a containment in contact with fluid systems, including those fluid systems moving through conduits, pipelines, tubulars, transfer lines, valves, and other places or equipment where hydrocarbon fluids are subject to corrosion. The compositions can be applied to a fluid system at various pH ranges, such as between about 2 to about 10, and temperatures, such as from about 25° C. to about 250° C., as well as various levels of water cut and/or various levels of salinity. The compositions can also be applied to a fluid system at various water cuts and salinity.

In embodiments, the fluid system comprises a hydrocarbon fluid, produced water, or combination thereof. As referred to herein, hydrocarbon fluid comprises crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, or combinations thereof. In many embodiments, hydrocarbon fluids comprise refined hydrocarbon product.

In embodiments the fluid system is contained in an oil or gas pipeline or refinery, including both offshore wells and on-shore wells. In embodiments the surface treated with the corrosion inhibiting compositions are metal surfaces in contact with fluid systems moving there through, including for example, conduits, pipelines, tubules, transfer lines, valves, and other places or equipment where hydrocarbon fluids are subject to corrosion. In an embodiment, the metal surface is used in recovery of a hydrocarbon fluid is an offshore well or an onshore well. In an embodiment, the metal surface is used in recovery of a hydrocarbon fluid and is a downhole pumping rod.

A fluid to which the compositions can be introduced can be a liquid hydrocarbon. The liquid hydrocarbon can be any type of liquid hydrocarbon. The fluid can be a refined hydrocarbon product.

The fluid can be contained in and/or exposed to many different types of apparatuses. In embodiments, the fluid is contained in a containment, such as an oil and gas pipeline. Additionally, the fluid can be contained in refineries, such as surfaces used in the recovery, transportation, refining and/or storage of hydrocarbon fluids or gases. Exemplary surfaces can include separation vessels, dehydration units, gas lines, oil and/or gas pipelines, or other part of an oil and/or gas refinery. Similarly, the fluid can be contained in and/or exposed to an apparatus used in oil extraction and/or production, such as a wellhead. The apparatus can be part of a coal-fired power plant. The apparatus can be a cargo vessel, a storage vessel, a holding tank, or a pipeline connecting the tanks, vessels, or processing units.

The system to be treated has at least one surface susceptible to corrosion, namely the surface comprises a metal surface subject to corrosion. In embodiments the surfaces can include a variety of metal surfaces that are subject to corrosion. The metals can comprise a component selected from the group consisting of mild steel, galvanized steel, carbon steel, aluminum, aluminum alloys, copper, copper nickel alloys, copper zinc alloys, brass, chrome steels, ferritic alloy steels, austenitic stainless steels, precipitation-hardened stainless steels, high nickel content steels, and any combination thereof.

The compositions can be applied by any appropriate method for ensuring dispersal through the fluid, including for example injecting, pumping, pouring, spraying, dripping, or otherwise adding. The compositions can be applied to a fluid using various well-known methods and they can be applied at numerous different locations throughout a given system. For example, the compositions can be injected using mechanical equipment such as chemical injection pumps, piping tees, injection fittings, atomizers, quills, and the like. The compositions can be pumped into an oil and/or gas pipeline using an umbilical line, including capillary string injection systems. U.S. Pat. No. 7,311,144 provides a description of an apparatus and methods relating to capillary injection, the disclosure of which is incorporated into the present application in its entirety.

The method comprises adding a corrosion inhibiting effective amount of the composition to the fluid system as a batch dosing to provide a film-like coating on a treated surface, such as a containment. Batch dosing is intended to substantially or preferably fully coat the surface, such as a containment. In embodiments the composition is applied as a direct batch application to fully coat the metal surface at a desired concentration, such as from about 5,000 ppm to about 1,000,000 ppm.

The dosage amounts of the compositions described herein to be added to the fluid system can be tailored by one skilled in the art based on factors for each fluid system in need of treatment, including, for example, content of fluid, volume of the fluid, surface area of the system, CO₂ content, temperatures, pH, and CO₂ content. In embodiments, an effective amount of the corrosion-inhibiting composition is from about 1 ppm to about 1,000,000 ppm, about 1,000 ppm to about 1,000,000 ppm, or from about 5,000 ppm to about 1,000,000 ppm based on the total volume of the system (i.e. the volume of the fluid treated according to the methods described herein).

In embodiments where the composition is added to the fluid system in a batch dosing in-line or offline. In embodiments, offline dosing provides a slug dosing suitable to coat the surfaces (e.g. containment) to provide barrier to the corrodents when the system is back in-line. The embodiments of batch dosing can be done when with or without fluid in the system. In embodiments, batch treatments can use up to 100% of the corrosion-inhibiting compositions applied between two spheres (e.g. pigs, as referred to in the industry) to coat the fully surface. In embodiments, the batch treatments can be applied with a diluent (e.g. diesel, hydrocarbon, etc.) between about 20-80%, often about 50%, dependent upon operator preference.

In embodiments the batch corrosion inhibitors can be applied at varying frequencies dependent upon the severity of the operating environment and conditions. In an embodiment, the corrosion-inhibiting compositions can be applied weekly, every other week, monthly, or quarterly. The methods described herein beneficially reduce the frequency of batch corrosion inhibitor application as a result of the corrosion-inhibiting compositions enhancing the film persistency of the compositions to improve the lifespan of the applied film while also decreasing the frequency of the chemical applications. This reduction in the frequency of chemical applications beneficially reduces costs while also decreasing chemical usage to streamline logistics, reduce chemical handling and any potential associated health and safety risks, reduces the operator's carbon footprint and thereby increasing sustainability of operations. The reduction in the frequency of chemical applications also reduces the need to employ more expensive coatings on infrastructure surfaces.

In embodiments the composition is added at a flow rate of a flow line in which the composition is used that can be between 0 and 100 feet per second, or between 0.1 and 50 fect per second. The compositions can be formulated with water in order to facilitate addition to the flow line.

In embodiments where the composition is added to the fluid system in a batch dosing application, the corrosion-inhibiting compositions provide improved corrosion inhibition in a system or on the treated surface in comparison to the same corrosion-inhibiting composition without the paraffinic oil solvent as measured by reduced milli-inches per year (mpy). The dosing of the corrosion-inhibiting compositions as batch inhibitors allows the chemistry to be applied directly onto the surface and form a film on the surface to act as a barrier to corrosion, including a barrier to the water electrolytes causing corrosion.

Beneficially as described herein the batch dosing of the compositions comprising the corrosion inhibitor and solvent(s) comprising paraffinic oil, wherein the paraffinic oil has between about 5-40 wt-% paraffin content, are distinguished from various continuous dosing injection of alternative corrosion inhibitors without the paraffinic oil solvent(s) that instead conventionally provide scale inhibitors and corrosion inhibitors. The inclusion of the solvent(s) comprising paraffinic oil provides benefits as described herein that enhance the efficacy and desirability of using batching dosing instead of continuous dosing for corrosion inhibition.

### Embodiments

The present disclosure is further defined by the following numbered embodiments:
1. A composition comprising: from about 1 wt-% to about 75 wt-% of at least one corrosion inhibitor; and from about 25 wt-% to about 99 wt-% of at least one solvent(s) comprising paraffinic oil, wherein the paraffinic oil has between about 5-40 wt-% paraffin content.
2. The composition of embodiment 1, wherein the paraffinic oil comprises n-paraffins.
3. The composition of any one of embodiments 1-2, wherein the paraffinic oil is a linear, aliphatic C9-C20 hydrocarbon.
4. The composition of any one of embodiments 1-3, further comprising an additional solvent in the composition to form a combined solvent, and wherein the paraffin content in the combined solvent remains above at least about 5 wt-%.
5. The composition of any one of embodiments 1-4, wherein the corrosion inhibitor comprises at least one of a fatty acid (or salts) amine condensate, a quaternary ammonium compound, phosphate ester, aromatic amine, organic sulfur compound and/or organic sulfonic acid amine.
6. The composition of embodiment 5, wherein the corrosion inhibitor is a fatty acid (or salts) amine condensate comprising an imidazoline or an imidazolinium compound.
7. The composition of embodiment 6, wherein the imidazoline has the chemical formula shown in (I), (II) or is an imidazoline derivative thereof:

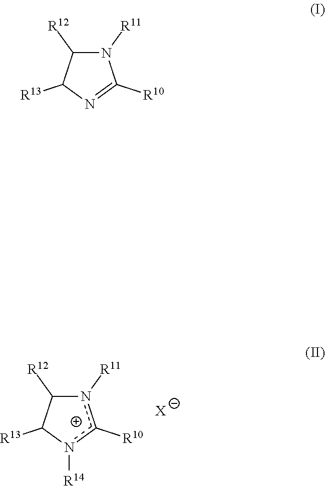

wherein: R¹⁰ is a C₁-C₂₀ alkyl or a C₁-C₂₀ alkoxyalkyl group; R¹¹ and R¹⁴ are independently hydrogen, C₁-C₆ alkyl, C₁-C₆ hydroxyalkyl, or C₁-C₆ arylalkyl; R¹² and R¹³ are independently a C₁-C₆ alkyl group or hydrogen; and X⁻ is a halide, carbonate, sulfonate, phosphate, or the anion of an organic carboxylic acid, or wherein the imidazoline is an imidazolinium compound that has the chemical formula shown in (III) or (IV):

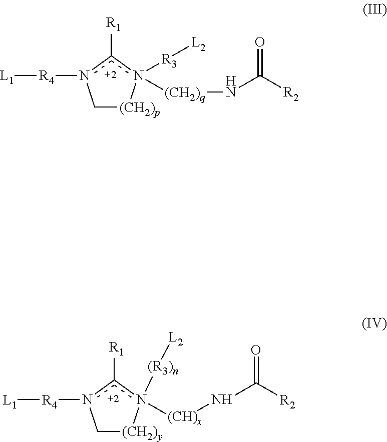

wherein: R₁, R₂, R₃ and R₄ are independently selected from the group consisting of unsubstituted branched, chain or ring alkyl or alkenyl having from 1 to about 29 carbon atoms; partially or fully oxygenized, sulfurized, and/or phosphorylized branched, chain, or ring alkyl or alkenyl having from 1 to about 29 carbon atoms; or a combination thereof; L₁ and L₂ are independently selected from the group consisting of —H, —COOH, —SO₃H, —PO₃H₂, —COOR₄, —CONH₂, —CONHR₄, —CON (R₄) 2, and combinations thereof; p is from 1 to about 5; and q is from 1 to about 10.
8. The composition of embodiment 5, wherein the corrosion inhibitor is a phosphate ester comprising mono-alkyl, di-alkyl, tri-alkyl, and/or alkylaryl phosphate esters.
9. The composition of embodiment 5, wherein the corrosion inhibitor is a quaternary ammonium compound with the chemical formula shown in (V)

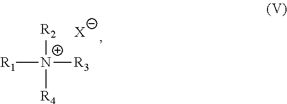

wherein R₁, R₂, and R₃ are independently C₁₂ to C₁₈ alkyl, R₄ is methyl or benzyl, and X⁻ is a halide or methosulfate.
10. The composition of embodiment 5, wherein the corrosion inhibitor is an aromatic amine comprising a pyridine or quinoline.
11. The composition of any one of embodiments 1-10, further comprising one or more additives selected from the group consisting of additional corrosion inhibitors, corrosion inhibitor intensifiers, pH control additives, surfactants, bactericides, biocides, defoamers, emulsifiers, friction reducers, drag reducing agents, flow improvers, viscosity reducers, sulfur compounds, and combinations thereof.
12. The composition of any one of embodiments 1-11, wherein the composition does not include a scale inhibitor.
13. A method of reducing, inhibiting or preventing both corrosion and metal wear of a metal surface comprising: contacting a metal surface with a composition according to any one of embodiments 1-12 to reduce, inhibit or prevent both corrosion and metal wear of the metal surface, wherein the metal surface is used in recovery, transportation, refining or storage of a hydrocarbon fluid.
14. The method of embodiment 13, wherein the composition is added as a direct batch application to fully coat the metal surface at a concentration of about 5,000 ppm to about 1,000,000 ppm.
15. The method of any one of embodiments 13-14, wherein the composition is added as a direct batch application on a weekly, biweekly, monthly, or quarterly basis.
16. The method of any one of embodiments 13-14, wherein the hydrocarbon fluid comprises crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, or combinations thereof, or wherein the hydrocarbon fluid is a refined hydrocarbon product.
17. The method of any one of embodiments 13-16, wherein the metal surface comprises carbon steel.
18. The method of any one of embodiments 13-17, wherein the metal surface used in recovery, transportation, refining or storage of the hydrocarbon fluid is under elevated carbon dioxide and elevated hydrogen sulfide causing high levels of metal loss and corrosion.
19. The method of any one of embodiments 13-18, wherein the metal surface is used in recovery of the hydrocarbon fluid is an offshore well or an onshore well, and wherein the metal surface is optionally a downhole pumping rod.
20. The method of any one of embodiments 13-19, wherein the method provides at least about a 25% improvement, or at least about 50% improvement in corrosion inhibition and/or wear metal loss rate in comparison to a composition comprising a non-paraffinic hydrocarbon solvent.
21. A treated metal containment comprising: a metal containment comprising a metal surface; and a barrier or film substantially coating the metal surface with a corrosive inhibiting effective amount of the composition according to any one of embodiments 1-12.
22. The treated metal containment of embodiment 21, wherein the corrosive inhibiting effective amount of the composition is from about 5,000 ppm to about 1,000,000 ppm, based on the total volume of the containment.
23. The treated metal containment of any one of embodiments 21-22, wherein the surface is a containment used in the production, transportation, storage and/or separation of crude oil, natural gas or a biofuel process.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

Testing was conducted to identify compositions for improved corrosion inhibition performance using batch treatment compositions. A blend of corrosion inhibitors described in Table 2 was utilized in the Example to combine with paraffin oil solvent and compare that with the same blend of corrosion inhibitors with a non-paraffin hydrocarbon solvent (xylene). The blend was a 50% TOFA: DETA (tall oil fatty acid, diethylenemine) imidazoline with xylene (Positive control). The evaluated corrosion-inhibiting composition according to the invention described herein included the same 50% TOFA: DETA imidazoline (CAS 68442-97-7) with paraffinic oil containing about 22 wt-% paraffin content, of which 8.9 wt-% are aliphatic C₁₆₊hydrocarbon, as shown in Table 1.

TABLE 1

| Compositions | Wt-% |
|---|---|
| Resolved n-Paraffins | 22.0 |
| (Resolved n-paraffins NC16+) | (8.9) |
| Resolved isoprenoids | 3.4 |
| Other resolved br/cyclics | 5.0 |
| Resolved aromatics | 3.0 |
| Resolved unknowns | 29.3 |
| Unresolved | 36.9 |
| Total | 100 |

The paraffin oil content is measured or characterized to identify the saturated alkanes that include paraffins, isoprenoids and other branched saturated compounds. Characterization of paraffin oil content therefore also includes the measurement of the resolved unknowns and potentially unresolved branched species, which are all achieved via gas chromatography which are methodology within the ordinary skill in the art. This measurement in Table 1 was performed using gas chromatography. However, one skilled in the art will ascertain that these measurements can be achieved by multidimensional chromatographic techniques as well including coupled liquid chromatography and gas chromatography (LC-GC).

The 8.9% resolved n-paraffins NC₁₆₊are part of the total of 22% resolved n-paraffins as shown in Table 1. Other components as listed in the table include resolved isoprenoids, other resolved branched (br)/cyclic compounds, resolved aromatics, resolved unknows and unresolved. The term “resolved unknowns” refer to peaks that have been chromatographically separated and integrated but not identified. The term “unresolved” are areas of the chromatographic baseline that have been integrated but are not resolved, commonly referred to as UCM or “unresolved complex mixture” that are thought to be composed of highly branched species which do not separate into individual peaks due to poor resolution on the column phase used for these particular analyses.

A rotating cylinder electrode (RCE) corrosion test with carbon dioxide saturated brine was performed in which, after a period of corrosion under chemical-free conditions in a corrosive environment, the steel coupon was batch treated in either of the blends and replaced back in the brine. Periodically (about every 24 h) the brine was replenished with fresh, chemical-free brine. The testing was performed using the following conditions to evaluate the corrosion inhibition performance of the various corrosion inhibitor blends on a carbon steel electrode (C₁₀₁₈ grade).

CONDITIONS: 60° C., CO₂ saturated fluids with 3% NaCl brine without liquid hydrocarbon with continuous CO₂ sparge, atmospheric pressure. A C₁₀₁₈ electrode/coupon was rotated with a wall shear stress of about 10 Pa. A pre-corrosion time (i.e. with no chemical inhibitor) was carried out for about 3 h before a “dip and drip” batch treatment was performed in which the C₁₀₁₈ steel coupon was dipped for about 5 seconds in the corrosion inhibitor composition and allowed to drip for 10 seconds to allow for excess product to be removed. After about 24 hours, the brine was replaced with fresh, chemical-free brine but otherwise the same (3% NaCl brine without liquid hydrocarbon, CO₂ saturated fluids at 60° C.). The brine was exchanged a further three times (for a total of four fluid exchanges) at approximately 24 hour periods. Fluid exchange refers to removing the test brine in the test cell and replacing with the same amount of otherwise the same fresh brine. For example, the second fluid exchange is a repeat of the first fluid exchange in which the test brine in the test cell is again replaced with the same amount of otherwise the same fresh brine; thereafter the third fluid exchange is a repeat of the first and second fluid exchange in which the test brine in the test cell is again replaced with the same amount of otherwise the same fresh brine; and the fourth fluid exchange is a repeat of the first, second and third fluid exchange in which the test brine in the test cell is again replaced with the same amount of otherwise the same fresh brine.

The results are summarized in Table 2 evaluating the persistency of the corrosion-inhibiting compositions using the RCE corrosion test with carbon dioxide saturated brine over a series of four fluid exchanges. The corrosion rate was assessed electrochemically using linear polarization resistance (LPR) methodology.

TABLE 2

| | Corrosion | | | | | Corrosion | | | | Corrosion | |
|---|---|---|---|---|---|---|---|---|---|---|---|
| | Rate after | | | Corrosion | % | rate 15 h | % | Corrosion | % | rate 15 h | % |
| | 3 h pre- | Corrosion | | rate 15 h | Protection | after | Protection | rate 20 h | Protection | after | Protection |
| | corrosion | Rate 15 h | % | after first | 15 h after | second | 15 h after | after third | 20 h after | fourth | 15 h after |
| | without | after | Protection | fluid | first | fluid | second | fluid | third | fluid | fourth |
| | batch CI | batch CI | 15 h after | exchange | fluid | exchange | fluid | exchange | fluid | exchange | fluid |
| Composition | (mpy) | (mpy) | batch CI | (mpy) | exchange | (mpy) | exchange | (mpy) | exchange | (mpy) | exchange |
| Blank | 284 | 488 | N/A | 575 | N/A | 575 | N/A | 575 | N/A | 575 | N/A |
| 50% | 310 | 3 | 99 | 74 | 87 | 296 | 49 | 463 | 19.5 | 444 | 23 |
| TOFA:DETA | | | | | | | | | | | |
| imidazoline | | | | | | | | | | | |
| 50% xylene | | | | | | | | | | | |
| (Positive | | | | | | | | | | | |
| Control) | | | | | | | | | | | |
| 50% | 294 | 3 | 99 | 12 | 96 | 61 | 89 | 141 | 75.5 | 278 | 52 |
| TOFA:DETA | | | | | | | | | | | |
| imidazoline | | | | | | | | | | | |
| 50% | | | | | | | | | | | |
| paraffinic oil | | | | | | | | | | | |

The corrosion test summarized in Table 2 takes place in a vessel with cap and stoppers in which the metal electrode is placed within approximately 1 L of brine. After the metal electrode is treated with the corrosion inhibitor composition an adsorbed film is formed, indicative of the film formed on a surface when treated with a batch corrosion inhibitor. Some chemicals desorb from the surface and an equilibrium is established between the chemical in the brine and that of the film on the surface. The purpose of the fluid exchange is to remove the free chemical in the brine to distort the equilibrium between that on the metal surface and that in the brine. A more persistent film has greater tenacity of the chemical molecules on the metal surface so less desorbs compared with a less persistent film. In turn the corrosion rate will remain lower with a more persistent film resulting in a longer lifetime than a less persistent one.

The example shows the corrosion inhibitor composition evaluated according to the claimed invention shows greater persistency and lower corrosion rate of the same imidazoline chemistry when applied with the paraffinic hydrocarbon solvent compared with the non-paraffinic xylene hydrocarbon. The corrosion inhibitor with paraffinic oil provided 96% protection (compared to 87%) after the first fluid exchange, 89% protection (compared to 49%) after the second fluid exchange, 75.5% protection (compared to 19.5%) after the third fluid exchange, and 52% protection (compared to 23%) after the fourth fluid exchange, demonstrating a clear improvement in persistency of the corrosion inhibiting film provided by the compositions set forth herein according to the invention.

### Example 2

Additional testing was conducted to further evaluate compositions having improved corrosion inhibition performance using batch treatment compositions under wheel-box corrosion testing method in addition to the RCE corrosion test in Example 1 showing the benefit of the paraffinic oil solvent with an imidazoline corrosion inhibitor. Additional types of corrosion inhibitors (aromatic amine, quaternary ammonium compound, and phosphate ester) as outlined in Table 3 were combined with paraffin oil solvent and compared with performance of the same corrosion inhibitors with a non-paraffin hydrocarbon solvent (xylene). The same paraffinic oil solvent containing about 22 wt-% paraffin content, of which 8.9 wt-% are aliphatic C₁₆₊hydrocarbon, as shown in Table 1, were used in this Example. The testing also included a diluted solvent concentration of the paraffinic oil at 5 wt-% and 10% to provide a further comparison to the 22 wt-%. The calculations for the diluted paraffinic oil concentration are for example, when using 45.65% of the solvent (which is 22% paraffinic oil) the 22% of 45.65% provides a corrosion inhibition composition with about 10% paraffinic oil.

The corrosion inhibitors utilized included the following: alkyl pyridine as the aromatic amine, benzyl-(C₁₂-C₁₈ Linear Alkyl)-Dimethyl-Ammonium Chloride as the quaternary ammonium compound, and Ethoxylated branched nonylphenol phosphate ester as the phosphate ester.

The Wheel-box corrosion tests were performed by a third-party laboratory using pre-weighed C₁₀₁₈ mild steel coupons (1/4″ X 7 3/8″) with a sandblast finish. The coupon was dipped for about 5 seconds in the corrosion inhibitor blend under assessment and allowed to drip for 10 seconds for excess product to be removed. The coupon was then placed in a vessel containing CO₂ saturated fluids of 3% NaCl brine without liquid hydrocarbon and closed. The vessel was then mounted on a wheel in a temperature-controlled cabinet at 60° C. The wheel was rotated at 26 rpm continuously for 72 hours (excluding during the fluid exchange every 24 hours). After 24 hours and then again at 48 hours and 72 hours, the fluids were replaced with chemical-free brine and ran for a further 24 hours. After the last brine replenishment at 72 hours the test was continued for a further 24 hours to a total of 96 hours. After the test, the coupons were removed from the vessel, cleaned and re-weighed and the corrosion rate determined by weight loss and the percentage inhibition determined by comparison to a blank, i.e. a test carried out under otherwise the same conditions but in the absence of any chemical treatment.

TABLE 3

| | Corrosion | % | Average % |
|---|---|---|---|
| Chemistry | Rate (MPY) | Protection | Protection |
| N/A | 18.13 | N/A | N/A |
| N/A | 18.67 | N/A | N/A |
| 50% Aromatic amine, 50% Xylene | 2.9336 | 84% | |
| 50% Aromatic amine, 50% Xylene | 3.1616 | 83% | 83% |
| 50% Aromatic amine, 50% paraffinic oil (~22% paraffin) | 2.8272 | 85% | |
| 50% Aromatic amine, 50% paraffinic oil (~22% paraffin) | 2.7056 | 85% | 85% |
| 50% Aromatic amine, 27.27% xylene, 22.73% paraffinic oil | 2.9336 | 84% | |
| (~5% paraffin) | | | |
| 50% Aromatic amine, 27.27% xylene, 22.73% paraffinic oil | 2.584 | 86% | 85% |
| (~5% paraffin) | | | |
| 50% quaternary ammonium compounds, 4.35% methanol, | 5.1376 | 72% | |
| 45.65% xylene | | | |
| 50% quaternary ammonium compounds, 4.35% methanol, | 4.9704 | 73% | 73% |
| 45.65% xylene | | | |
| 50% quaternary ammonium compounds, 4.35% methanol, | 2.3712 | 87% | |
| 45.65% paraffinic oil (~10% paraffin) | | | |
| 50% quaternary ammonium compounds, 4.35% methanol, | 2.7816 | 85% | 86% |
| 45.65% paraffinic oil (~10% paraffin) | | | |
| 50% quaternary ammonium compounds, 4.35% methanol, | 2.6448 | 86% | |
| 22.92% xylene, 22.73% paraffinic oil (~5% paraffin) | | | |
| 50% quaternary ammonium compounds, 4.35% methanol, | 2.5688 | 86% | 86% |
| 22.92% xylene, 22.73% paraffinic oil (~5% paraffin) | | | |
| 50% phosphate ester, 50% Xylene | 4.9552 | 73% | |
| 50% phosphate ester, 50% Xylene | 5.6544 | 69% | 71% |
| 50% phosphate ester, 50% paraffinic oil (~22% paraffin) | 3.0552 | 83% | |
| 50% phosphate ester, 50% paraffinic oil (~22% paraffin) | 3.42 | 81% | 82% |

The results demonstrate that the corrosion inhibition protection (average % protection) for the corrosion inhibition compositions is improved with the paraffinic oil solvent added to each class of corrosion inhibitors, including at concentrations of 5%, 10%, and 22% paraffinic oil solvent when compared to the non-paraffinic xylene hydrocarbons with the same corrosion inhibitors. In addition the corrosion rate (MPY) for each of the corrosion inhibition compositions with the paraffinic oil solvent, improved with the paraffinic oil solvent added to each class of corrosion inhibitors, including at concentrations of 5%, 10% and 22% paraffinic oil solvent, was decreased in comparison to those with the non-paraffinic xylene hydrocarbon with the same corrosion inhibitors. There was insufficient materials remaining to test the phosphate ester corrosion inhibitor with the lower/diluted concentrated of the paraffinic oil solvent. However, the results are expected to be consistent with the aromatic amine and the quaternary ammonium compound to provide the same benefits at the lower % of paraffinic oil solvent as depicted in Table 3. Overall this example demonstrates the benefit of the paraffinic oil solvent on persistency of the corrosion inhibitors.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A composition comprising:
from about 1 wt-% to about 75 wt-% of at least one corrosion inhibitor comprising at least one of a fatty acid (or salts) amine condensate, a quaternary ammonium compound, phosphate ester, aromatic amine, organic sulfur compound and/or organic sulfonic acid amine; and
from about 25 wt-% to about 99 wt-% of at least one solvent(s) comprising paraffinic oil, wherein the paraffinic oil has between about 5-40 wt-% paraffin content.

2. The composition of claim 1, wherein the paraffinic oil comprise n-paraffins.

3. The composition of claim 1, wherein the paraffinic oil is a linear, aliphatic C₉-C₂₀ hydrocarbon.

4. The composition of claim 1, further comprising an additional solvent in the composition to form a combined solvent, and wherein the paraffin content in the combined solvent remains above at least about 5 wt-%.

5. The composition of claim 1, wherein the corrosion inhibitor comprises at least one of a fatty acid (or salts) amine condensate, a quaternary ammonium compound, phosphate ester, and/or aromatic amine.

6. The composition of claim 5, wherein the corrosion inhibitor is a fatty acid (or salts) amine condensate comprising an imidazoline or an imidazolinium compound.

7. The composition of claim 6, wherein the imidazoline has the chemical formula shown in (I), (II) or is an imidazoline derivative thereof: 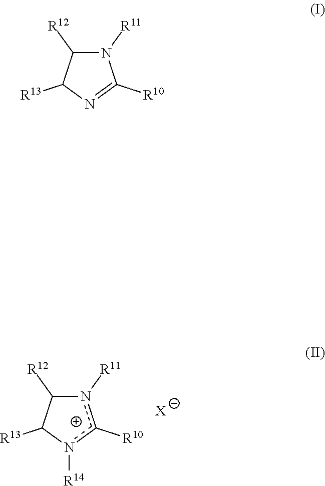
wherein:
R₁₀ is a C₁-C₂₀ alkyl or a C₁-C₂₀ alkoxyalkyl group;
R₁₁ and R₁₄ are independently hydrogen, C₁-C₆ alkyl, C₁-C₆ hydroxyalkyl, or C₁-C₆ arylalkyl;
R₁₂ and R₁₃ are independently a C₁-C₆ alkyl group or hydrogen; and
X⁻ is a halide, carbonate, sulfonate, phosphate, or the anion of an organic carboxylic acid,
or
wherein the imidazoline is an imidazolinium compound that has the chemical formula shown in (III) or (IV): 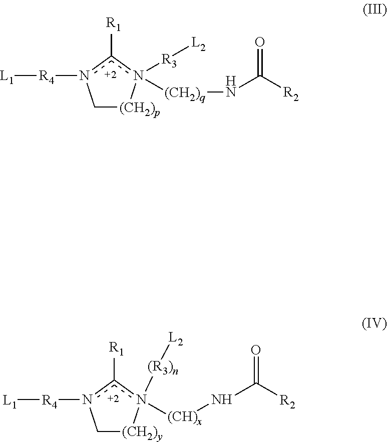
wherein:
R₁, R₂, R₃ and R₄ are independently selected from the group consisting of unsubstituted branched, chain or ring alkyl or alkenyl having from 1 to about 29 carbon atoms;
partially or fully oxygenized, sulfurized, and/or phosphorylized branched, chain, or ring alkyl or alkenyl having from 1 to about 29 carbon atoms; or a combination thereof;
L₁ and L₂ are independently selected from the group consisting of —H, —COOH, —SO₃H, —PO₃H₂, —COOR₄, —CONH₂, —CONHR₄, —CON(R₄)₂, and combinations thereof;
p is from 1 to about 5; and
q is from 1 to about 10.

8. The composition of claim 5, wherein the corrosion inhibitor is a phosphate ester comprising mono-alkyl, di-alkyl, tri-alkyl, and/or alkylaryl phosphate esters.

9. The composition of claim 5, wherein the corrosion inhibitor is a quaternary ammonium compound with the chemical formula shown in (V) 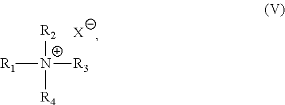
wherein R₁, R₂, and R₃ are independently C₁₂ to C₁₈ alkyl, R₄ is methyl or benzyl, and X⁻ is a halide or methosulfate.

10. The composition of claim 5, wherein the corrosion inhibitor is an aromatic amine comprising a pyridine or quinoline.

11. The composition of claim 1, further comprising one or more additives selected from the group consisting of additional corrosion inhibitors, corrosion inhibitor intensifiers, pH control additives, surfactants, bactericides, biocides, defoamers, demulsifiers, friction reducers, drag reducing agents, flow improvers, viscosity reducers, sulfur compounds, and combinations thereof.

12. The composition of claim 1, wherein the composition does not include a scale inhibitor.

13. A method of reducing, inhibiting or preventing both corrosion and metal wear of a metal surface comprising:
contacting a metal surface with a composition to reduce, inhibit or prevent both corrosion and metal wear of the metal surface,
wherein the composition comprises:
from about 1 wt-% to about 75 wt-% of at least one corrosion inhibitor comprising at least one of a fatty acid (or salts) amine condensate, a quaternary ammonium compound, phosphate ester, aromatic amine, organic sulfur compound and/or organic sulfonic acid amine; and
from about 25 wt-% to about 99 wt-% of at least one solvent(s) comprising paraffinic oil, wherein the paraffinic oil has between about 5-40 wt-% paraffin content;
wherein the metal surface is used in recovery, transportation, refining or storage of a hydrocarbon fluid.

14. The method of claim 13, wherein the composition is added as a direct batch application to fully coat the metal surface at a concentration of about 5,000 ppm to about 1,000,000 ppm.

15. The method of claim 13, wherein the composition is added as a direct batch application on a weekly, biweekly, monthly, or quarterly basis.

16. The method of claim 13, wherein the hydrocarbon fluid comprises crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, or combinations thereof, or wherein the hydrocarbon fluid is a refined hydrocarbon product, and/or wherein the metal surface comprises carbon steel.

17. The method of claim 13, wherein the metal surface used in recovery, transportation, refining or storage of the hydrocarbon fluid is under elevated carbon dioxide and elevated hydrogen sulfide causing high levels of metal loss and corrosion, and/or wherein the metal surface is used in recovery of the hydrocarbon fluid is an offshore well or an onshore well, and wherein the metal surface is optionally a downhole pumping rod.

18. The method of claim 13, wherein the method provides at least about a 25% improvement, or at least about 50% improvement in corrosion inhibition and/or wear metal loss rate in comparison to a composition comprising a non-paraffinic hydrocarbon solvent.

19. A treated metal containment comprising:
a metal containment comprising a metal surface; and
a barrier or film substantially coating the metal surface with a corrosive inhibiting effective amount of a composition comprising:
from about 1 wt-% to about 75 wt-% of at least one corrosion inhibitor comprising at least one of a fatty acid (or salts) amine condensate, a quaternary ammonium compound, phosphate ester, aromatic amine, organic sulfur compound and/or organic sulfonic acid amine; and
from about 25 wt-% to about 99 wt-% of at least one solvent(s) comprising paraffinic oil, wherein the paraffinic oil has between about 5-40 wt-% paraffin content.

20. The treated metal containment of claim 19, wherein the corrosive inhibiting effective amount of the composition is from about 5,000 ppm to about 1,000,000 ppm, based on the total volume of the containment, and/or wherein the surface is a containment used in the production, transportation, storage and/or separation of crude oil, natural gas or a biofuel process. .
